(19) United States
(12) Patent Application Publication
(10) Pub. No.: US 2021/0049629 A1
(43) Pub. Date: Feb. 18, 2021

(54) USER EXTRACTION DEVICE

(71) Applicant: NTT DOCOMO, INC., Chiyoda-ku (JP)

(72) Inventors: Chao XUE, Chiyoda-ku (JP); Tomohiro NAKAGAWA, Chiyoda-ku (JP)

(73) Assignee: NTT DOCOMO, INC., Chiyoda-ku (JP)

(21) Appl. No.: 16/981,027

(22) PCT Filed: Mar. 4, 2019
(86) PCT No.: PCT/JP2019/008443

§ 371 Date: Sep. 15, 2020

(30) Foreign Application Priority Data
Apr. 16, 2018 (JP) 2018-078266

(51) Int. Cl. G06Q 30/02; H04L 29/08

(52) U.S. Cl. CPC G06Q 30/0205; H04L 67/10; G06Q 30/0269; G06Q 30/0267; G06Q 30/0272; H04L 67/22

(57) ABSTRACT

A server includes a visit history acquiring unit configured to acquire check-in logs of each POI, a distribution result acquiring unit configured to acquire advertisement distribution logs for a plurality of users, a classification unit configured to classify the plurality of users into first users who have read advertisement information associated with the advertisement and second users who have not read the advertisement information, a visit user extracting unit configured to extract first visit users who have visited a POI among the first users and second visit users who have visited a POI among the second users for each POI, a POI extracting unit configured to extract specific POIs based on the number of visits of the first visit users and the second visit users to each POT, and a distribution target extracting unit configured to extract users who have visited a specific POI as distribution targets for the advertisement.

### TECHNICAL FIELD

One aspect of the present invention relates to a user extraction device.

### BACKGROUND ART

Conventionally, a structure for distributing an advertisement from an advertisement distributing server to a user terminal such as a smartphone or the like is known. As such advertisements, for example, there are an advertisement displayed inside a screen of an application (for example, a transfer search application or the like) operating on a terminal (an in-application advertisement), an advertisement displayed inside a web page (a web advertisement), and the like. Conventionally, distribution destinations of such advertisements (distribution target users) are extracted on the basis of a user's characteristic information including profile information such as a name, an address, an age, a sex, hobbies, and the like, action history information relating to web access such as accessed URLs and categories of the URLs, and the like (for example, see Patent Literatures 1 and 2).

### CITATION LIST

### Patent Literature

[Patent Literature 1] Japanese Unexamined Patent Publication No. 2011-59832

[Patent Literature 2] Japanese Unexamined Patent Publication No. 2011-238020

### SUMMARY OF INVENTION

### Technical Problem

However, in the extraction technique, it is necessary to acquire characteristic information (profile information, action history information, and the like) of all users who are candidates for distribution destinations of the advertisements in advance. In other words, distribution target users can be extracted only from users whose characteristic information has been acquired in advance. For this reason, in the extraction technique described above, the range of users from which distribution targets can be extracted are limited, and there are cases in which it is difficult to efficiently increase the number of distribution target users.

In addition, in selecting distribution target users, it is required to secure an effect of advertisement distribution such as a click-through rate of an advertisement (an in-application advertisement, a web advertisement, or the like), a staying time at an advertisement site (a landing page opened by clicking on an advertisement), and the like. In other words, when distribution target users for a specific advertisement are selected, it is required to select users who are interested in the advertisement as distribution targets. Here, in Patent Literature 2, a technique for extracting attributes (a sex, an age, a residence area, an occupation, and the like) common to a plurality of users having predetermined response results (clicking on advertisements and the like) and extracting users having common attributes that have been extracted as distribution targets is disclosed. However, in this technique, it is not checked whether or not the common attributes are attributes that are unique to users who have exhibited a predetermined response result (in other words, attributes that are notably represented by users who have exhibited a predetermined response result, compared to users who have not exhibited the predetermined response result). In a case in which it cannot be determined that the common attributes are attributes that are unique to users who have exhibited a predetermined response result, a possibility of extracting users who are not interested in an advertisement as distribution targets becomes high, and there is concern that the effect of advertisement distribution may be reduced.

Thus, an object of one aspect of the present invention is to provide a user extraction device capable of increasing the number of distribution target users while inhibiting reduction in the effect of advertisement distribution.

### Solution to Problem

A user extraction device according to one aspect of the present invention is a user extraction device extracting users who are targets for performing advertisement distribution to user terminals, the user extraction device including: a visit history acquiring unit configured to acquire visit history information including identification information used for identifying users who have visited a monitoring area for each of a plurality of monitoring areas set in advance; a distribution result acquiring unit configured to acquire distribution result information representing whether or not a user has read advertisement information associated with an advertisement for each of a plurality of users to whom the advertisement has been distributed; a classification unit configured to classify the plurality of users to whom the advertisement has been distributed into first users who have read the advertisement information associated with the advertisement and second users who have not read the advertisement information on the basis of the distribution result information; a visit user extracting unit configured to extract first visit users who have visited the monitoring area among the first users and second visit users who have visited the monitoring area among the second users for each of the monitoring areas on the basis of the visit history information; a monitoring area extracting unit configured to extract one or more specific monitoring areas from among the plurality of the monitoring areas on the basis of the number of visits of the first visit users and the number of visits of the second visit users to each of the monitoring areas; and a distribution target extracting unit configured to identify users who have visited at least one of the one or more specific monitoring areas on the basis of the visit history information for the one or more specific monitoring areas and extracts the identified users as distribution targets for the advertisement.

In a user extraction device according to one aspect of the present invention, visit history information for each of a plurality of monitoring areas (for example, so-called geo-fences) set in advance is acquired. In addition, the plurality of users to whom the advertisement has been distributed are classified into first users who have read the advertisement information associated with the advertisement (for example, users who have read a landing page (advertisement information) linked to the advertisement displayed inside a web page or in an application) and second users who have not read the advertisement information. Then, first visit users who have visited the monitoring area among the first users and second visit users who have visited the monitoring area among the second users are extracted for each of the monitoring areas, and one or more specific monitoring areas are extracted on the basis of the number of visits of the first visit users and the number of visits of the second visit users. Here, for example, one or more specific monitoring areas that the first users are estimated to be more likely to visit than the second users can be extracted on the basis of the number of visits of the first visit users and the number of visits of the second visit users. Therefore, according to the user extraction device, users who are highly likely to be interested in the advertisement (in other words, users who have visited the specific monitoring areas) can be extracted as distribution targets on the basis of distribution result information (whether the advertisement information has been read) for a plurality of users to whom the advertisement has been distributed and visit history information (monitoring areas that the users have visited). According to the description presented above, the number of distribution target users can be increased while inhibiting a reduction in an advertisement distribution effect (for example, a click-through rate of an advertisement or the like).

### Advantageous Effects of Invention

According to one aspect of the present invention, a user extraction device capable of increasing the number of distribution target users while inhibiting reduction in the effect of advertisement distribution can be provided.

### BRIEF DESCRIPTION OF DRAWINGS

FIG. 1 is a diagram illustrating the entire configuration of an advertisement distribution system including a server that is a user extraction device according to one embodiment.

FIG. 2 is a diagram illustrating one example of check-in logs.

FIG. 3 is a diagram illustrating one example of advertisement distribution logs.

FIG. 4 is a block diagram illustrating the functional configuration of a server.

FIG. 5 is a flowchart illustrating one example of operations of a server.

FIG. 6 is a flowchart illustrating one example of operations of a server.

FIG. 7 is a block diagram illustrating one example of the hardware configuration of a server.

### DESCRIPTION OF EMBODIMENTS

Hereinafter, one embodiment of the present invention will be described in detail with reference to the attached drawings. In description of the drawings, the same reference signs will be assigned to components that are the same or correspond to each other, and duplicate description thereof will be omitted.

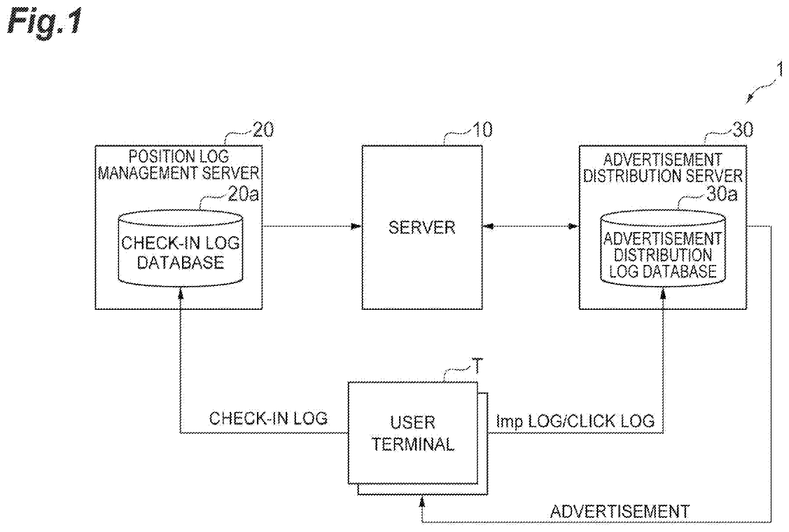

FIG. 1 is a diagram illustrating the entire configuration of an advertisement distribution system 1 including a server 10 that is a user extraction device according to one embodiment of the present invention. The advertisement distribution system 1 is a system that distributes a predetermined advertisement to a plurality of users (in other words, user terminals T held by a plurality of users). The advertisement distribution system 1 is configured to include a server 10, a position log management server 20, and an advertisement distribution server 30. The server 10 has a function of extracting distribution target users in accordance with an advertisement to be distributed in the advertisement distribution system 1, which will be described later in detail.

The position log management server 20 has a function of accumulating check-in logs (visit history information) representing histories of the user terminals T that have entered (visited; checked-in) a plurality of monitoring areas set in advance. For example, monitoring areas are virtual geographical ranges (for example, geo-fences, points of interest (POI), and the like) set in advance. In this embodiment, for example, monitoring areas are POIs representing a building, a store, various facilities, and the like. A user terminal T stores POI information (information such as a POI name registered for each POI in advance, a geographical range, and the like) in advance. For example, by using a position acquiring function using GPS, Wi-Fi (a registered trademark), Bluetooth (a registered trademark) low energy (BLE), and the like, when the user terminal T enters the range of a specific POI (a geographical range associated with the POI), the user terminal T detects that the user terminal T has entered (checked in) the range of the POI. When check-in is detected by the user terminal T, a check-in log for the check-in is generated in the user terminal T. The check-in log is transmitted from the user terminal T to the position log management server 20 and is stored in a check-in log database 20a included in the position log management server 20. Check-in logs of all the users (user terminals T) that are candidates for advertisement distribution destinations of the advertisement distribution server 30 are accumulated in the position log management server 20. In other words, in the position log management server 20, not only check-in logs of user terminals T that are targets for advertisement distribution of the advertisement distribution server 30 but also check-in logs of user terminals T that are not targets for advertisement distribution are accumulated at a time point at which the checks-in are detected.

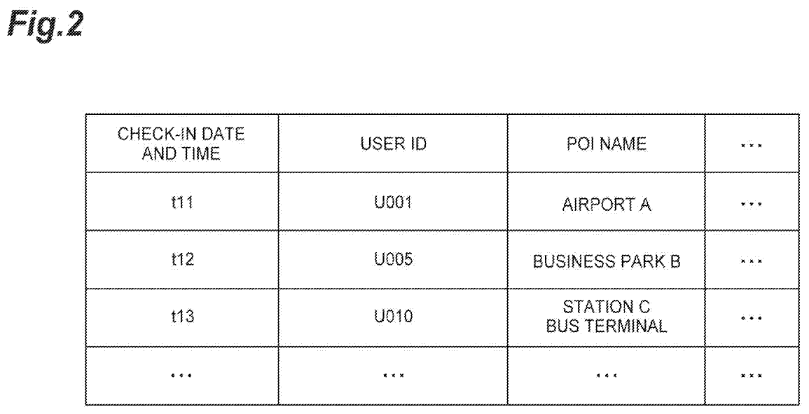

FIG. 2 is a diagram illustrating one example of check-in logs stored in the check-in log database 20a. In this example, a check-in log includes a check-in date and time, a user ID, and a POI name. The POI name is a name set in advance for uniquely identifying a POI. The check-in date and time are a date and time (time) at which a check-in has been detected by the user terminal T. In other words, the check-in date and time are time information representing a date and time at which a user visited a POI represented by the POI name. The user ID is identification information used for uniquely identifying a user of the user terminal T. In other words, the user ID is identification information used for identifying a user who has visited a POI represented by the POI name. A first check-in log illustrated in FIG. 2 represents that a user having a user ID “U001” checked in at an airport A at a time t11.

The advertisement distribution server 30 has a function of distributing (transmitting), for example, a predetermined advertisement requested from an advertiser to users (user terminals T) set in advance as distribution targets. In this embodiment, distribution destinations (distribution target users) of an advertisement are set for each advertisement. However, distribution destinations of an advertisement may be set for each of attributes such as a genre of advertisements, an advertiser, a commercial material (a product or a service) that is an advertisement target, and the like. For example, advertisements distributed by the advertisement distribution server 30 are an advertisement (in-application advertisement) displayed inside a screen of a predetermined application (for example, a transfer search application or the like) operating on the user terminal T, an advertisement displayed inside a web page (web advertisement), and the like.

In addition, the advertisement distribution server 30 also has a function of accumulating advertisement distribution logs (distribution result information) representing distribution results in the user terminal T to which an advertisement has been distributed. In this embodiment, as one example, advertisement distribution logs are accumulated in the advertisement distribution server 30 as below. That is, when an advertisement is displayed in the user terminal T to which the advertisement has been distributed, an imp log representing that an impression (advertisement display) has occurred in the user terminal T is generated. In addition, when a user selects the advertisement displayed in the user terminal T through clicking, touching, or the like and reads a landing page (advertisement information) linked to the advertisement, a click log representing that the advertisement has been clicked is generated in the user terminal T. The imp log and/or the click log generated in the user terminal T in this way are transmitted to the advertisement distribution server 30 and are stored in an advertisement distribution log database 30a included in the advertisement distribution server 30.

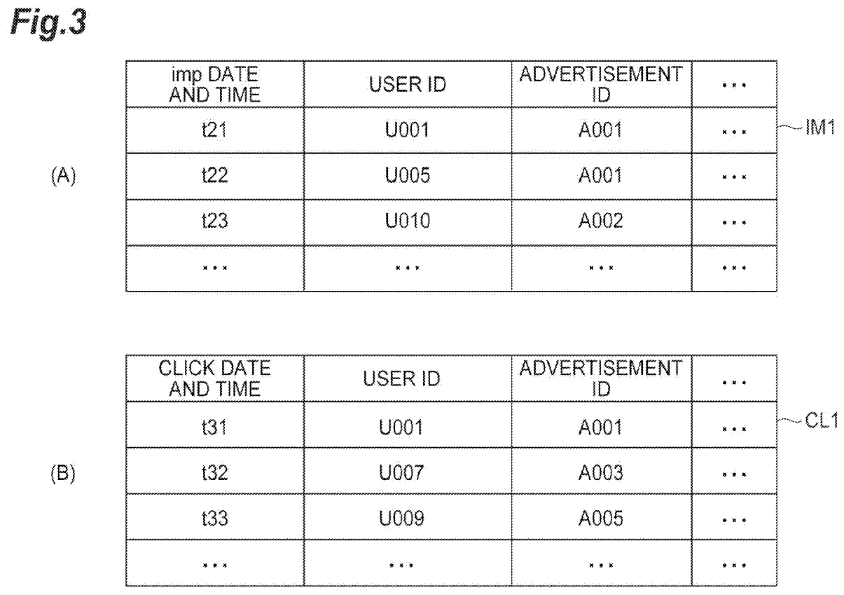

FIG. 3 is a diagram illustrating one example of advertisement distribution logs stored in the advertisement distribution log database 30a. (A) of FIG. 3 illustrates one example of imp logs. An imp log includes an imp date and time, a user ID, and an advertisement ID. The imp date and time are a date and time (time) at which an impression (advertisement display) is performed. The user ID is identification information used for uniquely identifying a user of the user terminal T. In this embodiment, the user ID included in the advertisement distribution log is the same as the user ID included in the check-in log described above. In other words, a user ID corresponding to the same user is the same in the advertisement distribution log and the check-in log. The advertisement ID is identification information used for uniquely identifying a displayed advertisement. (B) of FIG. 3 illustrates one example of click logs. The click log includes a click date and time representing a date and time (time) at which an advertisement has been clicked instead of the imp date and time, which is different from the imp log. The other items are similar to those of the imp log.

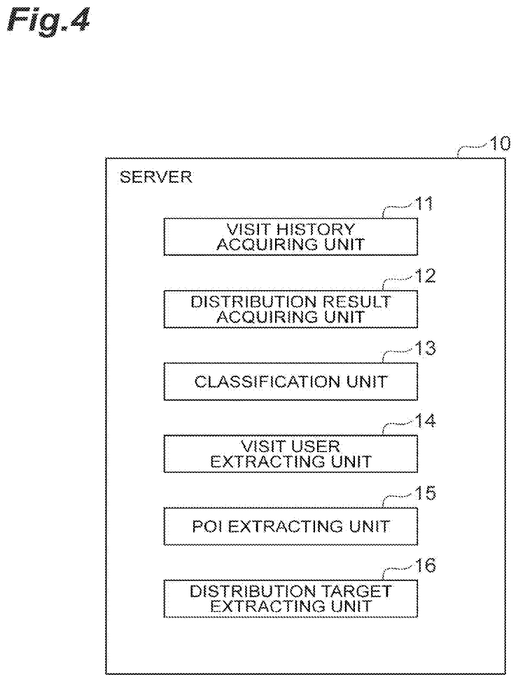

The server 10 has a function of extracting users who become targets for which an advertisement is distributed to user terminals T. More specifically, the server 10 extracts distribution target users for each advertisement (or for each attribute as described above) by referring to check-in logs accumulated in the check-in log database 20a and advertisement distribution logs accumulated in the advertisement distribution log database 30a. FIG. 4 is a block diagram illustrating the functional configuration of the server 10. As illustrated in the drawing, the server 10 includes a visit history acquiring unit 11, a distribution result acquiring unit 12, a classification unit 13, a visit user extracting unit 14, a POI extracting unit 15 (monitoring area extracting unit), and a distribution target extracting unit 16. Here, each function of the server 10 will be described by focusing on a case in which distribution target users of a specific advertisement A (an advertisement corresponding to a specific advertisement ID (here, as one example, “A001”)) are extracted as one example. In addition, as described above, in a case in which distribution target users are set for each attribute of advertisements, “a specific advertisement A” described above is rephrased as “an advertisement having a specific attribute.”

The visit history acquiring unit 11 acquires visit history information including a user ID used for identifying a user who has visited a POI for each of a plurality of POTs set in advance. In this embodiment, the visit history acquiring unit 11 acquires check-in logs (see FIG. 2) accumulated in the check-in log database 20a as the visit history information described above by accessing the position log management server 20.

The distribution result acquiring unit 12 acquires distribution result information representing whether or not a user has read advertisement information associated with the advertisement A for each of a plurality of users to whom the advertisement A has been distributed. In this embodiment, the distribution result acquiring unit 12 acquires an advertisement distribution log associated with the advertisement A (in other words, an advertisement distribution log corresponding to an advertisement ID “A001”) among advertisement distribution logs (imp logs and click logs (see FIG. 3)) accumulated in the advertisement distribution log database 30a as the distribution result information described above by accessing the advertisement distribution server 30.

The classification unit 13 classifies a plurality of users to whom the advertisement A has been distributed into first users who have read advertisement information associated with the advertisement A (for example, a landing page to which a display area of the advertisement A inside a web page or an application links) and second users who have not read the advertisement information, on the basis of the advertisement distribution logs associated with the advertisement A. More specifically, the first users are users who have read advertisement information associated with the advertisement A by clicking (including other selection operations such as touching; hereinafter the same) the advertisement A displayed on the user terminal T. The second users are users who have not clicked the advertisement A displayed on the user terminal T.

The classification unit 13 refers to an imp log (see (A) of FIG. 3) and a click log (see (B) of FIG. 3) associated with the advertisement A. Then, the classification unit 13 classifies users for whom an imp log and a click log corresponding to each other are present (in other words, user who have clicked the advertisement A displayed on the user terminal T) as first users. Here, for example, it can be determined whether or not an imp log and a click log correspond to each other as below. That is, in a case in which an imp log and a click log have a combination of the same user ID and the same advertisement ID, and a click date and time of the click log are within a time set in advance from the imp date and time of the imp log, it can be determined that the imp log and the click log correspond to each other. In other words, in a case in which a combination of an imp log and a click log, for which it can be determined that an advertisement A has been clicked after the advertisement A is displayed, is present, the classification unit 13 classifies a user associated with such an imp log and a click log as a first user. In the example illustrated in FIG. 3, in a case in which it is determined that an imp log IM1 and a click log CL1 having the same user ID “U001” and the same advertisement ID “A001” correspond to each other, the classification unit 13 classifies a user whose user ID is “U001” as a first user.

On the other hand, the classification unit 13 classifies a user for whom an imp log is present and a click log corresponding to the imp log is not present (in other words, a user who has not clicked an advertisement A displayed on the user terminal T) as a second user. In addition, depending on a structure of advertisement distribution provided by an advertisement distribution company (in other words, an advertisement distribution system performed in the advertisement distribution server 30), there may be a case in which the advertisement distribution server 30 collects only click logs and does not collect any imp log (in other words, in a case in which no imp log is present in the advertisement distribution log database 30a). In such a case, the classification unit 13 may classify a user for whom a click log is not present among users who are distribution targets for the advertisement A as a second user.

The visit user extracting unit 14 extracts first visit users who have visited a POI among the first users and second visit users who have visited a POI among the second users for each POI on the basis of the check-in logs acquired by the visit history acquiring unit 11. For example, first, the visit user extracting unit 14 selects a POI that is a processing target (hereinafter referred to as a “target POI”). Then, the visit user extracting unit 14 extracts a check-in log (in this embodiment, a check-in log including a “POI name” of the target POI) associated with the target POI from check-in logs (in other words, a plurality of check-in logs accumulated in the check-in log database 20a) acquired by the visit history acquiring unit 11.

Subsequently, the visit user extracting unit 14 searches for check-in logs associated with each of one or more first users (in other words, user who have clicked the advertisement A) from among check-in logs associated with the target POI. Users (user TDs) associated with check-in logs hit through such a search are users who have clicked the advertisement A and have visited the target POI (who have checked in the target POI). That is, through such a search, first visit users who have visited the target POI among the first users are identified, and check-in logs associated with the first visit users are extracted. By performing such a process for each POI, the visit user extracting unit 14 can extract first visit users and check-in logs with which the first visit users are associated for each POI.

Similarly, the visit user extracting unit 14 searches for check-in logs associated with each of one or more second users (in other words, users who have not clicked the advertisement A) among check-in logs associated with the target POI. Users (user IDs) associated with check-in logs hit through such a search are users who have not clicked the advertisement A and have visited the target POI (have checked in at the target POI). That is, through such a search, second visit users who have visited the target POI among the second users are identified, and check-in logs associated with the second visit users are extracted. By performing such a process for each POI, the visit user extracting unit 14 can extract second visit users and check-in logs with which the second visit users are associated for each POI.

The POI extracting unit 15 extracts one or more specific POIs (specific monitoring areas) among a plurality of POIs on the basis of the number of visits of the first visit users and the number of visits of the second visit users for each POI. More specifically, the POI extracting unit 15 calculates a score as will be described below for each POI and ranks POIs on the basis of the scores. Then, the POI extracting unit 15 extracts highly ranked POIs in a result of the ranking as specific POIs with priority. In this embodiment, the POI extracting unit 15 extracts N (here, N is a number set in advance) highly ranked POIs as specific POIs. Hereinafter, several examples of the sequence of extracting specific POIs will be described.

### First Example

In a first example, the POI extracting unit 15 extracts specific POIs on the basis of a ratio of the number of visits of the first visit users to the number of visits of the second visit users for each POI. More specifically, the POI extracting unit 15 extracts POIs for which the ratio of the number of visits of the first visit users to the number of visits of the second visit users is high as specific POIs with priority. For this purpose, for example, the POI extracting unit 15 may calculate a score 1 of each POI using the following Equation 1 and rank each POI on the basis of the score 1 of each POI. In the following Equation 1, “UU number” is the number of unique users. The unique user number is a value calculated by counting a plurality of the same user's visits to the same POI as one (one person).

Score 1=UU number of first visit users/UU number of second visit users (Equation 1)

By ranking POIs in order of highest to lowest score 1, a POI having a high ratio of the number of visits (here, the UU number) of the first visit users to the number of visits (here, the UU number) of the second visit users is extracted as a specific POI with priority. In other words, according to the first example, POIs having a high trend of the first users being more likely to visit than the second users can be extracted as specific POIs with priority on the basis of the ratio of the number of the first visit users to the number of the second visit users.

In addition, the POI extracting unit 15 may use a cumulative total number of people (a value calculated by counting a plurality of the same user's visits to the same POI as different visits) instead of the UU number. In other words, the POI extracting unit 15 may use “cumulative total number of first visit users/cumulative total number of second visit users” instead of the score 1 described above. However, by using the UU number as in Equation 1 described above, POIs having a high trend of the first users being more likely to visit than the second users can be more appropriately extracted by excluding the influence of particular users visiting the same place (POI) alone several times.

In addition, the POI extracting unit 15 may extract specific POIs from among POIs of which the UU numbers of the first visit users are equal to or higher than a threshold set in advance. In other words, the POI extracting unit 15 may exclude POIs of which the UU numbers of the first visit users are smaller than a threshold set in advance from candidates for specific POIs. According to this configuration, POIs that only a small number of specific first users have visited (in other words, places that cannot necessarily be regarded as places that all users interested in the advertisement A are likely to visit) can be appropriately excluded from candidates for specific POIs. In addition, for example, for a POI having a small number of visitors like a POI of which both the UU number of the first visit users and the UU number of the second visit users are “1,” the score 1 described above becomes “1 (=100%).” Generally, considering that the number of second users who do not click the advertisement A is much larger than the number of first users who click the advertisement A, the score “1” described above can be regarded to be a relatively high score. However, such a POI is a small spot that general users do not frequently visit and is not appropriate to be extracted as a specific POI. In a case in which such a POI is extracted as a specific POI, the number of users visiting such a POI is small, and accordingly, it becomes difficult to efficiently increase the number of distribution target users through the process of the distribution target extracting unit 16 to be described later. On the other hand, according to the process using a threshold as described above, such a small spot can be appropriately prevented from being extracted as a specific POI.

### Second Example

In the second example, the POT extracting unit 15 calculates a first average number of visits that is an average number of visits of the first visit users and a second average number of visits that is an average number of visits of the second visit users within a period set in advance for each POI and extracts specific POIs on the basis of the first average number of visits and the second average number of visits. It can be determined whether a visit is a visit within the period set in advance by referring to a check-in date and time included in the check-in log. In other words, the POI extracting unit 15 performs statistical processing by referring to only check-in logs of which a check-in date and time are within a period set in advance (for example, the past month or the like), whereby the first average number of visits and the second average number of visits can be calculated. For example, the POI extracting unit 15 may calculate a score 2 of each POI using the following Equation 2 and rank each POI on the basis of the score 2 of each POI. In other words, the POI extracting unit 15 may rank each POI on the basis of a difference between an average number of visits (a visiting frequency) of first visit users and an average number of visits of second visit users for each POI.

Score 2=First average number of visits−Second average number of visits (Equation 2)

Here, the first average number of visits at a POI is “the cumulative total number of first visit users who have visited the POI/the UU number of first visit users who have visited the POI.” In other words, the first average number of visits can be acquired by dividing the number of check-in logs with which first visit users extracted for the POI by the visit user extracting unit 14 are associated (in other words, a cumulative total number of first visit users who have visited the POI) by the UU number of the first visit users. Similarly, the second average number of visits of a certain POI is “the cumulative total number of second visit users who have visited the POI/the UU number of the second visit users who have visited the POI.” In other words, the second average number of visits can be acquired by dividing the number of check-in logs with which second visit users extracted for the POI by the visit user extracting unit 14 are associated (in other words, a cumulative total number of second visit users who have visited the POI) by the UU number of the second visit users.

By ranking POIs in order of the highest to lowest scores 2 described above, POIs having a trend of a higher visiting frequency (average number of visits) of the first users (who are likely to visit routinely) than that of the second users can be extracted with priority as specific POIs. In addition, in the first example described above, there is a trend that it is difficult for the score 1 of a large spot (POI) at which many users routinely gather to become high and be extracted as a specific POI. In other words, in a POI having a large scale (a POI at which the total number of check-ins is large), both the UU number of first visit users and the UU number of second visit users tend to increase, and there is a trend that it is difficult for the score 1 to become high even for the POI for which the UU number of the first visit users is larger than the UU number of the second visit users. For this reason, in the first example, there is a trend that it becomes easier for POIs having a small to medium scale to be extracted as specific POIs than POIs having a large scale. On the other hand, in the second example, since an average number of visits per user is used, POIs having a high visiting frequency of first users can be appropriately extracted even for the POIs having a large scale.

In addition, similar to the first example, also in the second example, the POI extracting unit 15 may extract specific POIs from among POIs for which the UU number of first visit users is equal to or larger than a threshold set advance. In other words, the POI extracting unit 15 may exclude POIs for which the UU number of first visit users is smaller than the threshold set in advance from candidates for specific POIs. According to this configuration, POIs to which an average number of visits becomes large due to an extremely large number of visits of only a small number of specific first users (in other words, places that cannot necessarily be regarded as places that all users interested in the advertisement A are likely to visit) can be appropriately excluded from candidates for specific POIs.

### Other Example

In addition, a score used for ranking each POI by the POI extracting unit 15 is not limited to the score 1 or the score 2 described above. For example, even when a score 3 that can be acquired by the following Equation 3 is used instead of the score 1, effects similar to those in a case in which the score 1 is used can be acquired.

Score 3=UU number of first visit users/(UU number of first visit users+UU number of second visit users) (Equation 3)

In addition, the POI extracting unit 15 may calculate a final score of each POI on the basis of a plurality of scores based on mutually-different viewpoints (in the example described above, the score 1 and the score 2) and rank each POI on the basis of the final score. For example, the POI extracting unit 15 may rank each POI using a score 4 that can be acquired using the following Equation 4. Here, α and β are parameters set in advance for determining weighting factors of the score 1 and the score 2.

Score 4=α×Score 1+β×Score 2 (Equation 4)

The distribution target extracting unit 16 identifies users who have visited at least any one of N specific POIs on the basis of check-in logs for the N specific POIs extracted by the POI extracting unit 15 and extracts the identified users as distribution targets for the advertisement A. For example, the distribution target extracting unit 16 extracts all the user IDs included in check-in logs for N specific POIs (in other words, users who have visited at least any one of the N specific POIs). Then, the distribution target extracting unit 16 extracts users that have not been set as distribution targets for the advertisement A among the users (user IDs) extracted in this way as new distribution targets for the advertisement A. According to such a process, users who have visited POIs that may be likely visited by users who are interested in the advertisement A (users considered to be more highly likely to be interested in the advertisement A than that of randomly-extracted users) can be added to distribution targets for the advertisement A.

In addition, when distribution targets for an advertisement (hereinafter, an “advertisement B”) of which advertisement distribution results have not been checked are selected, the distribution target extracting unit 16 cannot rank POIs based on the advertisement distribution results (advertisement distribution logs). Thus, in such a case, the distribution target extracting unit 16 may select distribution targets (initial distribution target users) as below on the basis of check-in logs. More specifically, a predetermined category may be associated in advance with the advertisement B that is a target for selecting distribution target users. For example, in a case in which the advertisement B is an advertisement relating to rent-a-bicycle (a fee-based bicycle rental business), users who are currently using buses for commuting are assumed as substantial customers, and accordingly, one or more predetermined categories “Bus use” may be associated with the advertisement B. In addition, the distribution target extracting unit 16 maintains a POI list that is a table, in which a POI and one or more predetermined categories (for example, a category selected from a category list that is common to a category associated with the advertisement B) are associated with each other for each POI, such that it can be referred to. For example, a category “Bus use” may be associated with a POI representing a bus terminal or the like disposed in front of a station. The distribution target extracting unit 16 extracts a POI (here, as one example, a POI representing a bus terminal associated with “Bus use”) associated with a category that is the same as or similar to a category (here, as one example, “Bus use”) associated with the advertisement B from the POI list. Then, the distribution target extracting unit 16 identifies users (user IDs) having check-in histories for the POI and extracts identified users as distribution targets for the advertisement B by referring to check-in logs for the extracted POI. In this way, in a case in which an advertisement distribution log cannot be used, the distribution target extracting unit 16 can extract initial distribution target users on the basis of results of user's visits to the POI by referring to check-in logs. According to such a process, in the example described above, the advertisement B relating to rent-a-bicycle can be distributed to users who are currently using buses for commuting (in other words, users who are likely to be interested in rent-a-bicycle as a substitutive moving means). In addition, since a strong effect cannot be expected even when an advertisement is distributed to users located far from a geographical range in which a commercial material as an advertisement target is provided, geographical ranges such as cities, wards, towns, and villages may be used as the categories described above. In addition, after the advertisement B is distributed to the initial distribution target users, and advertisement distribution logs are acquired by the distribution result acquiring unit 12, distribution target users of the advertisement B can be extracted on the basis of both of check-in logs and advertisement distribution logs through a process similar to the process for the advertisement A described above.

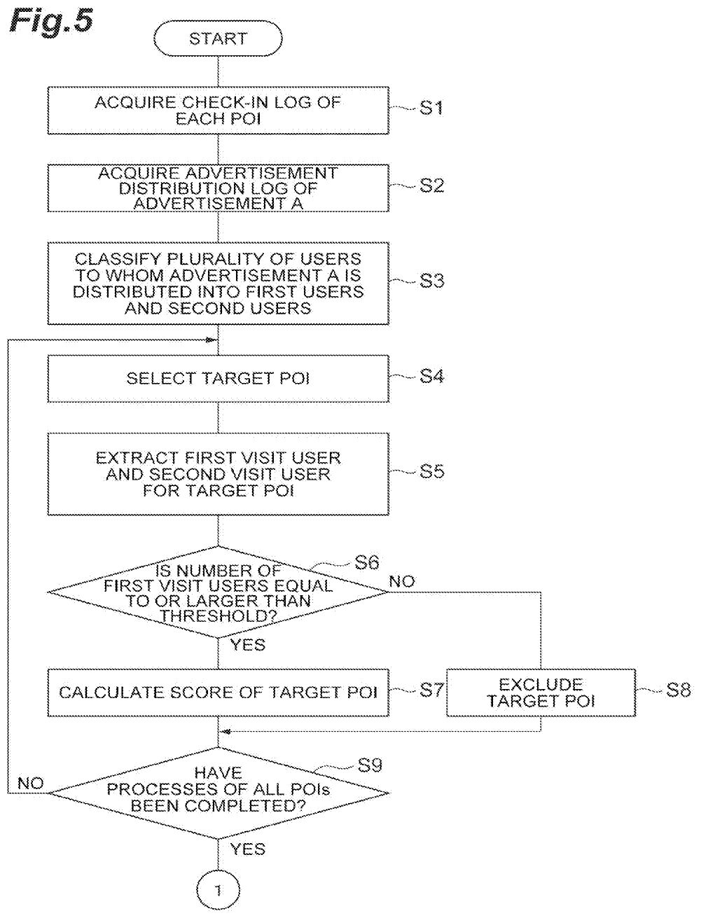

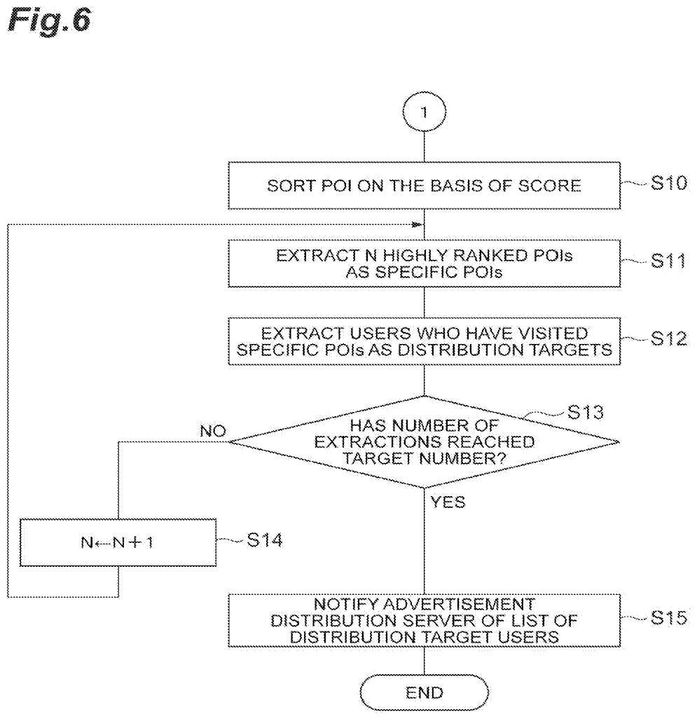

Next, one example of the operation of the server 10 will be described with reference to FIGS. 5 and 6. Here, a case in which a process of extracting new distribution target users corresponding to a predetermined target number or more is performed for a specific advertisement A will be focused.

First, the visit history acquiring unit 11 acquires check-in logs (see FIG. 2) of each POI accumulated in the check-in log database 20a by accessing the position log management server 20 (Step S1).

In addition, the distribution result acquiring unit 12 acquires advertisement distribution logs associated with the advertisement A among advertisement distribution logs (imp logs and click logs (see FIG. 3)) accumulated in the advertisement distribution log database 30a by accessing the advertisement distribution server 30 (Step S2). Step S1 and Step S2 are processes that are independent from each other, and thus, Step S2 may be executed simultaneously with Step S1 or before Step S1.

Subsequently, the classification unit 13 classifies a plurality of users to whom the advertisement A has been distributed into first users who have clicked the advertisement A and second users who have not clicked the advertisement A by referring to advertisement distribution logs associated with the advertisement A acquired in Step S2 (Step S3).

Subsequently, the visit user extracting unit 14 selects one POI that becomes a processing target (hereinafter, referred to as a “target POI”) (Step S4). Then, the visit user extracting unit 14 extracts first visit users who have visited the target POI among the first users and second visit users who have visited the target POI among the second users on the basis of the check-in logs acquired in Step S1 (Step S5).

Subsequently, the POI extracting unit 15 determines whether or not the number of the first visit users (UU number) of the target POI extracted in Step S5 is equal to or larger than a threshold set in advance (Step S6). In a case in which the number of first visit users is equal to or larger than the threshold (Step S6: Yes), the POI extracting unit 15 calculates a score of the target POI using Equation 1 to Equation 4 and the like described above (Step S7). On the other hand, in a case in which the number of the first visit users is smaller than the threshold (Step S6: No), the POI extracting unit 15 excludes the target POI from candidates for the specific POI (Step S8).

The processes of Steps S4 to S8 described above are executed for all the POIs (for example, POIs that are registered as processing targets in advance by an operator or the like) (Step S9: No). After the processes for all the POIs are completed (Step S9: Yes), the POI extracting unit 15 sorts (ranks) POIs on the basis of the scores of the POIs (Step S10). Subsequently, the POI extracting unit 15 extracts N highly ranked POIs as specific POIs (Step S11).

Subsequently, the distribution target extracting unit 16 identifies users who have visited at least one of the N specific POIs on the basis of the check-in logs for the N specific POIs extracted in Step S11 and extracts the identified users as distribution targets for the advertisement A (Step S12). More specifically, the distribution target extracting unit 16 extracts users who have not been set as distribution targets for the advertisement A among users who have visited at least one of the N specific POIs as new distribution targets for the advertisement A.

Subsequently, the distribution target extracting unit 16 determines whether or not the number of distribution target users (number of extractions) extracted in Step S12 has reached a target number set in advance (Step S13). In a case in which the number of extractions has not reached the target number (Step S13: No), “N+1” is set as new “N” (Step S14), and the processes of Step S11 and subsequent steps are executed again. According to such a sequence, the process of increasing the number of specific POIs by one each time until the number of extractions reaches the target number is executed. On the other hand, in a case in which the number of extractions has reached the target number (Step S13: Yes), the distribution target extracting unit 16 determines the distribution target users and notifies the advertisement distribution server 30 of a list of the distribution target users (for example, a list of user IDs to be newly added as distribution targets). According to this process, adding users extracted as new distribution targets in Step S12 as new distribution destinations, the advertisement distribution server 30 can distribute the advertisement A.

The check-in logs for each of a plurality of POIs (for example, so-called geo-fences) set in advance are acquired by the server 10 described above. In addition, a plurality of users to whom the advertisement A has been distributed are classified into first users who have read advertisement information associated with the advertisement A and second users who have not read the advertisement information. Then, first visit users who have visited a POI among the first users and second visit users who have visited the POI among the second users are extracted for each POI, and one or more (N in this embodiment) specific POIs that the first users are estimated to visit more likely than the second users are extracted on the basis of the number of visits of the first visit users and the number of visits of the second visit users. Therefore, according to the server 10, users who are highly likely to be interested in the advertisement A (in other words, users who have visited the specific POIs) can be extracted as distribution targets on the basis of distribution result information (advertisement distribution logs indicating whether or not the advertisement information has been read) for a plurality of users to whom the advertisement A has been distributed and visit history information (check-in logs representing POIs that the users have visited). In other words, users who are more highly likely to read a landing page by clicking the advertisement A displayed on the user terminal T than randomly-extracted users can be extracted as new distribution targets for the advertisement A. According to the description presented above, the number of distribution target users can be efficiently increased while inhibiting a reduction in an advertisement distribution effect (for example, a click-through-rate of an advertisement, a user's staying time in the landing page (site staying time), and the like).

In addition, in a distribution target extracting process performed by the server 10 described above, characteristic information including profile information (a name, an address, an age, a sex, hobbies, and the like), an action history relating to a web access, and the like need to be collected and accumulated in advance for each user who is a candidate for an advertisement distribution destination like in a conventional case. More specifically, according to the distribution target extracting process described above, a user holding a user terminal T that can collect check-in logs for a POI can be extracted as a new advertisement distribution target even when the above-described characteristic information of the user has not been collected. Accordingly, the distribution target extracting process performed by the server 10 described above is particularly advantageous in a case in which it is required to continuously maintain or improve the advertisement distribution effect over a long period (in other words, in a case in which a distribution target user is required to be added or changed in a flexible manner) and the like. In addition, since characteristic information of a user who is a distribution target candidate does not need to be maintained, a storage capacity required for the server 10 (or an external device that can be accessed by the server 10) can be drastically decreased compared to that of a conventional case.

In addition, the distribution target extracting unit 16 may extract users who are not set as distribution targets for the advertisement A at the current time point as new distribution targets for the advertisement A among users who have visited at least one of N specific POIs and exclude some or all of the users who are set as distribution targets for the advertisement A at the current time point from the distribution targets. For example, the distribution target extracting unit 16 may continuously set the first users (in other words, users who have clicked the advertisement A) as distribution targets for the advertisement A and exclude the second users from the distribution targets for the advertisement A. In this way, by setting new users (users who have visited at least one of N specific POIs) who are highly likely to click the advertisement A as new distribution targets instead of the second users who become a cause for lowering the advertisement distribution effect, the advertisement distribution effect can be further improved.

In addition, in the embodiment described above, although the server 10 has been described as a device different from any one of the position log management server 20 and the advertisement distribution server 30, the server 10 may be configured as a system (device) including some or all of the functions of the position log management server 20 and advertisement distribution server 30.

The block diagram (FIG. 4) used for description of the embodiment described above illustrates blocks in units of functions. Such functional blocks (component units) are realized by an arbitrary combination of hardware and/or software. In addition, a means for realizing each functional block is not particularly limited. In other words, each functional block may be realized by one device that is combined physically and/or logically or a plurality of devices by directly and/or indirectly (for example, using a wire and/or wirelessly) connecting two or more devices separated physically and/or logically.

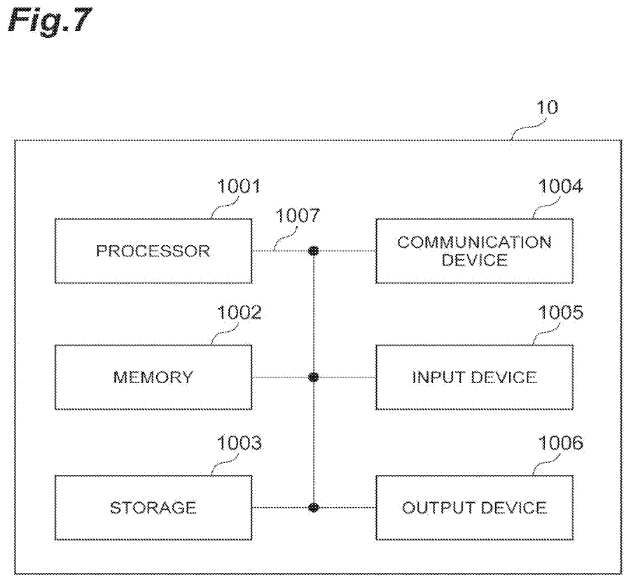

For example, the server 10 according to one embodiment may function as a computer that performs the process of the server 10 according to the embodiment described above. FIG. 7 is a diagram illustrating one example of the hardware configuration of the server 10 according to this embodiment. The server 10 described above, physically, may be configured as a computer device including a processor 1001, a memory 1002, a storage 1003, a communication device 1004, an input device 1005, an output device 1006, a bus 1007, and the like.

In addition, in the following description, a term “device” may be rephrased with a circuit, a device, a unit, or the like. The hardware configuration of the server 10 may be configured to include one or a plurality of devices illustrated in FIG. 7 and may be configured without including some devices.

Each function of the server 10 is realized as the processor 1001 performs an arithmetic operation by causing predetermined software (a program) to be read onto hardware such as the processor 1001, the memory 1002, and the like and controls communication using the communication device 1004 and data reading and/or data writing using the memory 1002 and the storage 1003.

The processor 1001, for example, controls the entire computer by operating an operating system. The processor 1001 may be configured by a central processing unit (CPU) including an interface with peripheral devices, a control device, an arithmetic operation device, a register, and the like.

In addition, the processor 1001 reads a program (a program code), a software module, and/or data from the storage 1003 and/or the communication device 1004 into the memory 1002 and executes various processes in accordance with these. As the program, a program causing a computer to execute at least some of the operations described in the embodiment described above is used. For example, the POI extracting unit 15 of the server 10 may be realized by a control program that is stored in the memory 1002 and is operated by the processor 1001, and the other functional blocks illustrated in FIG. 4 may be similarly realized. Although the various processes described above have been described to be executed by one processor 1001, the processes may be executed simultaneously or sequentially by two or more processors 1001. The processor 1001 may be mounted using one or more chips. In addition, the program may be transmitted from a network through a telecommunication line.

The memory 1002 is a computer-readable recording medium and, for example, may be configured by at least one of a read only memory (ROM), an erasable programmable ROM (EPROM), an electrically erasable programmable ROM (EEPROM), a random access memory (RAM), and the like. The memory 1002 may be referred to as a register, a cache, a main memory (a main storage device), or the like. The memory 1002 can store a program (a program code), a software module, and the like that are executable for performing an information processing method (for example, the sequences illustrated in the flowchart illustrated in FIGS. 5 and 6) according to the embodiment described above.

The storage 1003 is a computer-readable recording medium and, for example, may be configured by at least one of an optical disc such as a compact disc ROM (CD-ROM), a hard disk drive, a flexible disk, a magneto-optical disk (for example, a compact disc, a digital versatile disc, or a Blue-ray (registered trademark) disc), a smart card, a flash memory (for example, a card, a stick, or a key drive), a floppy (registered trademark) disk, a magnetic strip, and the like. The storage 1003 may be referred to as an auxiliary storage device. The storage medium described above, for example, may be a database including the memory 1002 and/or a storage 1003, a server, or any other appropriate medium.

The communication device 1004 is hardware (a transmission/reception device) for performing inter-computer communication through a wired and/or wireless network and, for example, may be called also as a network device, a network controller, a network card, a communication module, or the like.

The input device 1005 is an input device (for example, a keyboard, a mouse, a microphone, a switch, buttons, a sensor, or the like) that accepts an input from the outside. The output device 1006 is an output device (for example, a display, a speaker, an LED lamp, or the like) that performs output to the outside. In addition, the input device 1005 and the output device 1006 may have an integrated configuration (for example, a touch panel).

In addition, devices such as the processor 1001, the memory 1002, and the like are connected using a bus 1007 for communication of information. The bus 1007 may be configured as a single bus or buses different between devices.

In addition, the server 10 may be configured to include hardware such as a microprocessor, a digital signal processor (DSP), an application specific integrated circuit (ASIC), a programmable logic device (PLD), a field programmable gate array (FPGA), or the like, and a part or the whole of each functional block may be realized by the hardware. For example, the processor 1001 may be mounted using at least one of such hardware components.

As above, while the present invention has been described in detail, it is apparent to a person skilled in the art that the present invention is not limited to the embodiments described in this specification. The present invention may be performed as a modified or changed form without departing from the concept and the scope of the present invention set in accordance with the claims. Thus, the description presented in this specification is for the purpose of exemplary description and does not have any limited meaning for the present invention.

The processing sequence, the sequence, the flowchart, and the like of each aspect/embodiment described in this specification may be changed in order as long as there is no contradiction. For example, in a method described in this specification, elements of various steps are presented in an exemplary order, and the method is not limited to the presented specific order.

The input/output information and the like may be stored in a specific place (for example, a memory) or managed using a management table. The input/output information and the like may be overwritten, updated, or additionally written. The output information and the like may be deleted. The input information and the like may be transmitted to another device.

A judgment may be performed using a value (“0” or “1”) represented by one bit, may be performed using a Boolean value (true or false), or may be performed using a comparison between numerical values (for example, a comparison with a predetermined value).

The aspects/embodiments described in this specification may be individually used, used in combination, or be switched therebetween in accordance with execution.

It is apparent that software, regardless whether it is called software, firmware, middleware, a microcode, a hardware description language, or any other name, be widely interpreted to mean a command, a command set, a code, a code segment, a program code, a program, a subprogram, a software module, an application, a software application, a software package, a routine, a subroutine, an object, an executable file, an execution thread, an order, a function, and the like.

In addition, software, a command, and the like may be transmitted and received via a transmission medium. For example, in a case in which software is transmitted from a website, a server, or any other remote source using wiring technologies such as a coaxial cable, an optical fiber cable, a twisted pair, a digital subscriber line (DSL) and the like and/or radio technologies such infrared rays, radio waves, and microwaves, and the like, such wiring technologies and/or radio technologies are included in the definition of the transmission medium.

Information, a signal, and the like described in this specification may be represented using any one among other various technologies. For example, data, an instruction, a command, information, a signal, a bit, a symbol, a chip, and the like described over the entire description presented above may be represented using a voltage, a current, radiowaves, a magnetic field or magnetic particles, an optical field or photons, or an arbitrary combination thereof.

In addition, a term described in this specification and/or a term that is necessary for understanding this specification may be substituted with terms having the same meaning or a meaning similar thereto.

In addition, information, a parameter, and the like described in this specification may be represented using absolute values, relative values from predetermined values, or other corresponding information.

A name used for each parameter described above is not limited in any aspect. In addition, numerical equations using such parameters may be different from those that are explicitly disclosed in this specification.

Description of “on the basis of” used in this specification does not mean “only on the basis of” unless otherwise mentioned. In other words, description of “on the basis of” means both “only on the basis of” and “at least on the basis of.”

As long as “include,” “including,” and modifications thereof are used in this specification or the claims, such terms are intended to be inclusive like a term “comprising.” In addition, a term “or” used in this specification or the claims is intended to be not an exclusive logical sum.

Other than a case in which clearly only one device is present in a context or technically, a device includes a plurality of devices.

A term “determining” used in this specification may include various operations of various types. The “determining,” for example, may include a case in which judging, calculating, computing, processing, deriving, investigating, looking up (for example, looking up a table, a database, or any other data structure), or ascertaining is regarded as “determining.” In addition, “determining” may include a case in which receiving (for example, receiving information), transmitting (for example, transmitting information), input, output, or accessing (for example, accessing data in a memory) is regarded as “determining” Furthermore, “determining” may include a case in which resolving, selecting, choosing, establishing, comparing, or the like is regarded as “determining.” In other words, “determining” includes a case in which a certain operation is regarded as “determining.”

In the entirety of the present disclosure, unless a singularity is represented clearly from the context, it includes a plurality thereof.

### REFERENCE SIGNS LIST

1 Advertisement distribution system
10 Server (user extraction device)
11 Visit history acquiring unit
12 Distribution result acquiring unit
13 Classification unit
14 Visit user extracting unit 14
15 POI extracting unit (monitoring area extracting unit)
16 Distribution target extracting unit
T User terminal

1. A user extraction device extracting users who are targets for performing advertisement distribution to user terminals, the user extraction device comprising:
a visit history acquiring unit configured to acquire visit history information including identification information used for identifying users who have visited a monitoring area for each of a plurality of monitoring areas set in advance;
a distribution result acquiring unit configured to acquire distribution result information representing whether or not a user has read advertisement information associated with an advertisement for each of a plurality of users to whom the advertisement has been distributed;
a classification unit configured to classify the plurality of users to whom the advertisement has been distributed into first users who have read the advertisement information associated with the advertisement and second users who have not read the advertisement information on the basis of the distribution result information;
a visit user extracting unit configured to extract first visit users who have visited the monitoring area among the first users and second visit users who have visited the monitoring area among the second users for each of the monitoring areas on the basis of the visit history information;
a monitoring area extracting unit configured to extract one or more specific monitoring areas from among the plurality of the monitoring areas on the basis of the number of visits of the first visit users and the number of visits of the second visit users to each of the monitoring areas; and
a distribution target extracting unit configured to identify users who have visited at least one of the one or more specific monitoring areas on the basis of the visit history information for the one or more specific monitoring areas and extracts the identified users as distribution targets for the advertisement.

2. The user extraction device according to claim 1, wherein the monitoring area extracting unit extracts the monitoring area having a higher ratio of the number of visits of the first visit users to the number of visits of the second visit users as the specific monitoring area with higher priority.

3. The user extraction device according to claim 2, wherein, for each of the monitoring areas, the monitoring area extracting unit calculates a unique user number of the first visit users who have visited the monitoring area as the number of visits of the first visit users and calculates a unique user number of the second visit users who have visited the monitoring area as the number of visits of the second visit users.

4. The user extraction device according to claim 1, wherein the monitoring area extracting unit calculates a first average number of visits that is an average number of visits of the first visit users and a second average number of visits that is an average number of visits of the second visit users within a period set in advance for each of the monitoring areas and extracts the one or more specific monitoring areas on the basis of the first average number of visits and the second average number of visits.

5. The user extraction device according to claim 1, wherein the monitoring area extracting unit extracts the one or more specific monitoring areas from among the monitoring areas for which a unique user number of the first visit users is equal to or larger than a threshold set in advance.

6. The user extraction device according to claim 2, wherein the monitoring area extracting unit calculates a first average number of visits that is an average number of visits of the first visit users and a second average number of visits that is an average number of visits of the second visit users within a period set in advance for each of the monitoring areas and extracts the one or more specific monitoring areas on the basis of the first average number of visits and the second average number of visits.

7. The user extraction device according to claim 3, wherein the monitoring area extracting unit calculates a first average number of visits that is an average number of visits of the first visit users and a second average number of visits that is an average number of visits of the second visit users within a period set in advance for each of the monitoring areas and extracts the one or more specific monitoring areas on the basis of the first average number of visits and the second average number of visits.

8. The user extraction device according to claim 2, wherein the monitoring area extracting unit extracts the one or more specific monitoring areas from among the monitoring areas for which a unique user number of the first visit users is equal to or larger than a threshold set in advance.

9. The user extraction device according to claim 3, wherein the monitoring area extracting unit extracts the one or more specific monitoring areas from among the monitoring areas for which a unique user number of the first visit users is equal to or larger than a threshold set in advance.

10. The user extraction device according to claim 4, wherein the monitoring area extracting unit extracts the one or more specific monitoring areas from among the monitoring areas for which a unique user number of the first visit users is equal to or larger than a threshold set in advance.

11. The user extraction device according to claim 5, wherein the monitoring area extracting unit extracts the one or more specific monitoring areas from among the monitoring areas for which a unique user number of the first visit users is equal to or larger than a threshold set in advance.

12. The user extraction device according to claim 6, wherein the monitoring area extracting unit extracts the one or more specific monitoring areas from among the monitoring areas for which a unique user number of the first visit users is equal to or larger than a threshold set in advance.
